(19) United States
(12) Patent Application Publication
(10) Pub. No.: US 2008/0132620 A1
(43) Pub. Date: Jun. 5, 2008

(54) POLYMER COMPOSITION CONTAINING FLAME RETARDANT AND PROCESS FOR PRODUCING THE SAME

(76) Inventors: Hoe Hin CHUAH, Houston, TX (US); Kailash Dangayach, Houston, TX (US); Venkataratnam Ramachandran, Dalton, GA (US)

Correspondence Address: Shell Oil Company, 910 Louisiana, Houston, TX, 77002, US

(21) Appl. No.: 11/939,426

(22) Filed: Nov. 13, 2007

Related U.S. Application Data
(60) Provisional application No. 60/865,986, filed on Nov. 15, 2006.

(51) Int. Cl. C08K 5/51; C08K 5/53

(52) U.S. Cl. 524/133

(57) ABSTRACT

The present invention provides a polymer composition containing a flame retardant. In particular, the invention provides a polymer composition containing poly(trimethylene terephthalate) and a flame retardant having a flame retardant component that melts at a temperature of equal to or below 280° C. The present invention also provides a process for producing such a composition, and materials incorporating such polymer compositions.

### CROSS REFERENCE TO EARLIER APPLICATION

The present application claims the benefit of the filing date of U.S. Provisional patent application Ser. No. 60/865,986 filed Nov. 15, 2006, the disclosure of which is incorporated herein by reference.

### FIELD OF THE INVENTION

The present invention is directed to a composition containing a flame retardant and a process for producing the composition. More particularly, the present invention is directed to a polymer composition containing a flame retardant comprising a phosphinate metal salt having a melting point equal to or below 280° C. and a process for producing the same.

### BACKGROUND OF THE INVENTION

Flame retardants are frequently added to or incorporated in polymers to provide flame retardant properties to the polymers. The flame retardant polymers may then be used in applications in which resistance to flammability is desirable, for example, in textile or carpet applications.

A large variety of compounds have been used to provide flame retardancy to polymers. For example, numerous classes of phosphorous containing compounds and nitrogen containing compounds have been utilized as flame retardants in polymers. Classes of such phosphorous containing compounds include inorganic phosphorous compounds such as red phosphorous, monomeric organic phosphorous compounds, orthophosphoric esters or condensates thereof, phosphoric ester amides, phosphonitrilic compounds, phosphine oxides (e.g. triphenylphosphine oxides), and metal salts of phosphinic, phosphoric, and phosphonic acids. The metal salts of phosphinic acids (metal salt phosphinates) that have been utilized as flame retardants in polymers comprise a large variety of compounds themselves, including monomeric, oligomeric, and polymeric species with one, two, three, or four phosphinate groups per coordination center including metals selected from beryllium, magnesium, calcium, strontium, barium, titanium, zirconium, vanadium, antimony, bismuth, chromium, molybdenum, tungsten, manganese, iron, ruthenium, cobalt, rhodium, iridium, nickel, platinum, palladium, copper, silver, zinc, cadmium, mercury, aluminum, tin, and lead.

Such flame retardant compounds have been used in a wide variety of polymers. For example, phosphorous containing compounds have been used as flame retardants in polymers such as polymers of mono- and di-olefins such as polypropylene, polyisobutylene, polyisoprene, and polybutadiene; aromatic homopolymers and copolymers derived from vinyl aromatic monomers such as styrene, vinylnaphthalene, and p-vinyltoluene; hydrogenated aromatic polymers such as polycyclohexylethylene; halogen containing polymers such as polychloroprene and polyvinylchloride; polymers derived from α,β-unsaturated acids and derivatives thereof such as polyacrylates and polyacrylonitriles; polyamides such as nylon and 6,6′-nylon, and polyesters such as polyethylene terephthalate (PET), and polybutylene terephthalate (PBT).

Poly(trimethylene terephthalate) (“PTT”) is a polyester that has recently been commercially developed as a result of the recent availability of commercial quantities of 1,3-propanediol, a requisite monomer for forming PTT. PTT has an array of desirable characteristics when used in fiber applications relative to other polymers used in fiber applications such as polyamides, polypropylenes, and its polyester counterparts PET and PBT, such as soft touch, resilience and shape recovery due to its spring-like molecular structure, and good stain resistance.

It is desirable to provide PTT with effective flame retardant properties by incorporating a flame retardant in the PTT polymer. In particular, it is desirable to provide a PTT polymer composition with effective flame retardant properties by incorporating an effective amount of flame retardant in a PTT polymer while retaining sufficient polymer strength so the PTT polymer may be utilized in the formation of PTT fibers, filaments, films and molding compositions. The strength of a PTT polymer is, in part, determined by its intrinsic viscosity, where increasing intrinsic viscosity corresponds to increasing polymer strength. A PTT polymer having a low intrinsic viscosity may not have sufficient strength to be melt spun into a fiber or filament since the polymer breaks as it is spun, may not have sufficient strength to be formed into a molded composition since the polymer may collapse, and may not have sufficient strength to be formed into a film. The strength of a PTT polymer for fiber or filament formation may also be affected by particulate concentration, where a high particulate concentration, e.g. greater than 5 wt. %, may render the polymer unspinnable into a fiber or filament since the polymer is weakened by intercalcated particulates such that the polymer breaks as it is spun.

U.S. Pat. Nos. 4,180,495; 4,208,321; and 4,208,322 provide poly(metal phosphinate) flame retardants that may be added to polyester resins, polyamide resins, or polyester-polyamide resins. One of the polyester resins to which such flame retardants may be added is PTT. The list of poly(metal phosphinate) flame retardants that may be added to the polyester, polyamide, or polyester-polyamide resins is extensive, and includes the metal salts of phosphinic acids (metal salt phosphinates) listed above—e.g. monomeric, oligomeric, and polymeric species with one, two, three, or four phosphinate groups per coordination center including metals selected from beryllium, magnesium, calcium, strontium, barium, titanium, zirconium, vanadium, antimony, bismuth, chromium, molybdenum, tungsten, manganese, iron, ruthenium, cobalt, rhodium, iridium, nickel, platinum, palladium, copper, silver, zinc, cadmium, mercury, aluminum, tin, and lead. The poly(metal phosphinate) flame retardants may be utilized in the polymers in an amount from 0.25 to 30 parts by weight per 100 parts by weight of polymer resin. These references, however, do not provide a PTT polymer composition containing an effective amount of flame retardant where the flame retardant PTT polymer composition retains sufficient strength so the PTT polymer may be utilized in the formation of PTT fibers, filaments, films and/or molding compositions.

U.S. Patent Publication No. 2005/0272839 provides a compression granulated flame retardant composition containing a) a pulverulent phosphinate and/or diphosphinate and/or their polymers as a flame retardant and b) a fusible zinc phosphinate as a compacting agent that may have some flame retardant activity. The phosphinates or diphosphinates are metal salts in which the metal is Mg, Ca, Al, Sb, Sn, Ge, Ti, Zn, Fe, Zr, Ce, Bi, Sr, Mn, Li, Na, and/or K. The fusible zinc phosphinate has a melting point of from 40° C. to 250° C. The phosphinates or diphosphinates comprise from 50 to 98 wt. % of the compression-granulated flame retardant composition, and the fusible zinc phosphinate forms from 2 to 50 wt. % of the flame retardant composition. The compression granulated flame retardant may be used in a large variety of polymers including polyesters, specifically including PET and PBT. The reference, however, does not provide a PTT polymer composition containing an effective amount of flame retardant where the flame retardant PTT polymer composition retains sufficient strength so the PTT polymer may be utilized in the formation of PTT fibers, filaments, films, and/or molding compositions.

### SUMMARY OF THE INVENTION

In one aspect, the invention is directed to a flame retardant polymer composition comprising a polymer comprising at least 75 wt. % poly(trimethylene terephthalate) comprised of at least 75 mol % trimethylene terephthalate; and

a flame retardant comprising a flame retardant phosphinate metal salt having a melting point of equal to or below 280° C., wherein said flame retardant phosphinate metal salt comprises from 0.25 wt. % to 5 wt. % of the composition and wherein the composition has an intrinsic viscosity of at least 0.7 dl/g. In one embodiment of the invention, the polymer composition is a polymer molding, in another embodiment, the polymer composition is a film, in another embodiment the polymer composition is a filament, in yet another embodiment the polymer composition is a fiber, and in still another embodiment, the composition is a resin.

In another aspect, the invention is directed to a process for preparing a polymer containing a flame retardant comprising preparing a mixture at a temperature of from 180° C. to 280° C. of 1) a flame retardant comprising a flame retardant phosphinate metal salt and 2) a polymer comprising at least 75 wt. % poly(trimethylene terephthalate) comprised of at least 75 mol % trimethylene terephthalate, wherein:

a) the flame retardant phosphinate metal salt of the flame retardant is selected so that the phosphinate metal salt has a melting point equal to or below 280° C.;
b) the temperature is selected so the polymer and the phosphinate metal salt each have a melting point below the selected temperature;
c) the amount of flame retardant is selected so the phosphinate metal salt is from 0.25 wt. % to 5 wt. % of the combined flame retardant and polymer; and
d) the amount of flame retardant in the mixture relative to the amount of polymer in the mixture is selected so the mixture has an intrinsic viscosity of at least 0.7 dl/g.
5

### DETAILED DESCRIPTION OF THE INVENTION

The present invention provides a PTT polymer composition containing a flame retardant in an amount sufficient to provide effective flame retardancy to the polymer wherein the flame retardant PTT polymer composition retains sufficient strength so the flame retardant PTT polymer may be utilized in the formation of PTT fibers, filaments, films, and/or molding compositions. In the composition of the present invention, only a minor amount of flame retardant is required to provide effective flame retardancy in the flame retardant PTT polymer composition because the flame retardant includes at least one flame retardant phosphinate metal salt having a melting point equal to or below 280° C. (hereinafter such phosphinate metal salt(s), either singular or plural, may be referred to as a “meltable phosphinate metal salt”). The flame retardant has an effective degree of flame retardancy since 1) the meltable phosphinate metal salt in the PTT polymer composition has been found to possess sufficient flame retardancy in and of itself to provide effective flame retardancy in a PTT polymer (without additional flame retardants that are non-fusible particulates); and 2) the meltable phosphinate metal salt of the flame retardant is well dispersed in the polymer due to its melting point and the melting point of the PTT polymer being equivalent to or below the temperature at which the PTT polymer and the flame retardant are mixed, thereby providing the PTT polymer with a well distributed flame retardant which is distributed uniformly or substantially uniformly through the composition. Minimal flame retardant is required to provide effective flame retardance in the PTT polymer composition as a result of the substantially uniform distribution of the flame retardant in the PTT polymer.

The flame retardant PTT polymer composition of the present invention retains sufficient strength so the polymer may be utilized in the formation of PTT fibers, filaments, films, and/or molding compositions since relatively little of the flame retardant comprising the flame retardant meltable phosphinate salt is required in the polymer to provide effective flame retardancy to the PTT polymer. Therefore, the flame retardant PTT polymer composition has an intrinsic viscosity of at least 0.7 dl/g, or at least 0.8 dl/g, or at least 0.9 dl/g, and may be used to be melt spun into fibers or filaments or may be used to form films or molding compositions formed of the flame retardant PTT polymer. In addition, with respect to fiber formation from the flame retardant PTT polymer composition, the composition contains an effective amount of flame retardant without the addition of greater than 5 wt. % of flame retardants that are particulate at a temperature of greater than 280° C. so that the flame retardant PTT polymer composition has sufficient strength to be melt spun into fibers without particulate induced breakage. 5

The flame retardant polymer composition of the present invention contains a polymer comprising at least 75 wt. % poly(trimethylene terephthalate) comprised of at least 75 mol % trimethylene terephthalate (the “PTT polymer”) and a flame retardant comprising at least one flame retardant phosphinate metal salt having a melting point of equal to or below 280° C. (hereinafter the “meltable phosphinate metal salt”, where the singular is also intended to encompass the plural). The flame retardant meltable phosphinate metal salt comprises from 0.25 wt. % to 5 wt. % of the composition, and comprises at least 10 wt. %, and may comprise greater than 50 wt. %, or at least 75 wt. % of the flame retardant. The composition of the invention has an intrinsic viscosity of at least 0.7 dl/g, or at least 0.8 dl/g, or at least 0.9 dl/g at a temperature between the melting point of the composition and 280° C.

The PTT polymer may be a homopolymer, a PTT co-polymer containing minor amounts of non-PTT co-monomers, a blend of a PTT homopolymer with minor amounts of other polymers, or a PTT co-polymer containing minor amounts of non-PTT co-monomers blended with minor amounts of other polymers. The PTT polymer, regardless of other non-PTT co-monomers or other polymers therein, contains at least 75 wt. % poly(trimethylene terephthalate) comprised of at least 75 mol % trimethylene terephthalate.

“Non-PTT co-monomers” as used herein, are defined as monomers in a polymer containing repeating trimethylene terephthalte units that may replace at least one of the monomers that form trimethylene terephalate units, specifically 1,3-propanediol and terephthalic acid or dimethylesterterephthalate, and be incorporated into the polymeric chain without forming a trimethylene terephthalate unit. Such non-PTT co-monomers include, but are not limited to, ethylene glycol, butylene glycol, 1,4 cyclohexanedimethanol, oxalic acid, succinic acid, phthalic acid, 2,6-naphthalenedicarboxylic acid, 5-sodiumsulfoisophthalic acid, isophthalic acid, and/or adipic acid. The PTT polymer of the flame retardant polyester composition may contain up to 25 mol % non-PTT co-monomers, or may contain at most 15 mol %, or at most 10 mol %, or at most 5 mol % non-PTT co-monomers. The PTT polymer may contain no non-PTT co-monomers (i.e. the PTT polymer is a homopolymer).

Other polymers that may be included in the flame retardant polymer composition of the present invention along with the PTT polymer include polyesters such as poly(ethylene terephthalate), poly(butylene terephthalte), poly(ethylene naphthalate), and poly(trimethylene naphthalate) and polyamides such as nylon-6, or nylon-6,6. Such polymers may be added as reinforcing agents, as defined below. In one embodiment, nylon-6 or nylon-6,6 is included with the PTT polymer in the composition of the invention to offset some or all intrinsic viscosity reduction that may be induced in the PTT polymer as a result of the presence of the flame retardant meltable phosphinate metal salt in the composition. In one embodiment of the composition of the present invention, the other polymers that may be included in the composition of the present invention with the PTT polymer do not exceed 25 wt. %, or 15 wt. %, or 10 wt. %, or 5 wt. % of the composition. In another embodiment of the composition of the invention, the other polymers in the composition other than the PTT polymer are selected from the group consisting of polyamides and polyesters other than polyesters containing at least 75 mol % poly(trimethylene terephthalate), or a mixture thereof, where the PTT polymer is present in the composition in a weight ratio to the other polymers of at least 3:1, or at least 4:1, or at least 5:1, or at least 6:1. In an embodiment, no other polymer is present in the flame retardant PTT polymer composition than PTT itself.

The flame retardant PTT polymer composition may have an intrinsic viscosity of at least 0.7 dl/g, or at least 0.8 dl/g, or at least 0.9 dl/g. In an embodiment, the flame retardant PTT polymer composition of the present invention may have an intrinsic viscosity of from 0.7 to 1.4 dl/g. Preferably, the composition of the invention has an intrinsic viscosity of from 0.8 to 1.2 dl/g. In accordance with the present invention, intrinsic viscosity is measured by dissolving a polymer in a solvent of phenol and 1,1,2,2-tetrachloroethane (60 parts phenol, by volume, 40 parts 1,1,2,2-tetrachloroethane, by volume) and measuring at 30° C. the intrinsic viscosity of the dissolved polymer on a relative viscometer, preferably Model No. Y501B available from Viscotek Company.

The flame retardant PTT polymer composition of the present invention contains a flame retardant that contains at least one flame retardant meltable phosphinate metal salt having a melting point of equal to or below 280° C., or below 270° C., or below 250° C., or below 230° C., or below 200° C., or below 180° C. The flame retardant meltable phosphinate metal salt comprises from 0.25 wt. % to 5 wt. % of the composition, or may comprise from 0.3 wt. % to 4 wt. % of the composition, or may comprise from 0.5 wt. % to 2.5 wt. % of the composition.

The flame retardant meltable phosphinate metal salt comprises at least 10 wt. %, and may comprise greater than 50 wt. % of the flame retardant in the flame retardant PTT polymer composition of the present invention, or may comprise greater than 75 wt. % of the flame retardant in the composition. The flame retardant in the flame retardant PTT polymer composition of the invention may consist essentially of the flame retardant meltable phosphinate metal salt.

The flame retardant meltable phosphinate metal salt(s) may be any phosphinate metal salt having the structure shown in formula (I) and having a melting point equal to or below 280° C., or below 270° C., or below 250° C., or below 230° C., or below 200° C., or below 180° C.

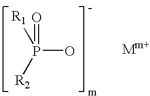

### (I)

In formula (I), R₁ and R₂ may be identical or different, and are C₁-C₁₈ alkyl, linear or branched, and/or aryl, M is Mg, Ca, Al, Sb, Ge, Ti, Fe, Zr, Ce, Bi, Sr, Mn, Li, Na, or K, and m is from 1 to 4. The flame retardant meltable phosphinate metal salt must have a melting point equal to or below 280° C., or below 270° C., or below 250° C., or below 230° C., or below 200° C., or below 180° C. so that it may be melted and dispersed in the PTT polymer at a temperature that will not substantially degrade the polymer.

In a preferred embodiment, the flame retardant meltable phosphinate metal salt is a zinc phosphinate having a melting point equal to or below 280° C., or below 270° C., or below 250° C., or below 230° C., or below 200° C., or below 180° C. and having the structure of formula (I) where R₁ and R₂ are identical or different and are hydrogen, C₁-C₁₈ alkyl, linear or branched, and/or aryl, M is zinc, and m is 2. In one embodiment the zinc phosphinate has a melting point of equal to or below 280° C., or below 270° C., or below 250° C., or below 230° C., or below 200° C., or below 180° C. and is of the formula (I), where R₁ and R₂ are identical or different and are methyl, ethyl, isopropyl, n-propyl, t-butyl, n-butyl, or phenyl, M is zinc, and m is 2. In a preferred embodiment, the zinc phosphinate is selected from the group consisting of zinc diethylphosphinate, zinc dimethylphospinate, zinc methylethylphosphinate, zinc diphenylphosphinate, zinc ethylbutylphosphinate, and zinc dibutylphosphinate. In a most preferred embodiment, the zinc phosphinate is zinc diethylphosphinate.

The flame retardant of the flame retardant PTT polymer composition of the invention may contain a flame retardant component that does not have a melting point equal to or below 280° C., which is defined for purposes of the present invention as the “non-fusible flame retardant component”. The non-fusible flame retardant component of the flame retardant, if present, does not have a melting point equal to or below 280° C., although the non-fusible flame retardant component may, but does not necessarily, have a melting point above 280° C. since the non-fusible flame retardant component may decompose rather than melt at temperatures above 280° C. Such non-fusible flame retardants include phosphinate metal salts of the formula (I) that do not melt at or below a temperature of 280° C., other phosphorous containing compounds that are non-fusible at a temperature of equal to or below 280° C., including inorganic phosphorous compounds such as red phosphorous, monomeric organic phosphorous compounds, orthophosphoric esters or condensates thereof, phosphoric ester amides, phosphonitrilic compounds, phosphine oxides (e.g. triphenylphosphine oxides), and metal salts of phosphoric, and phosphonic acids, diphosphinic salts, and nitrogen containing compounds such as benzoguanamine compounds, ammonium polyphosphate, and melamine compounds such as melamine borate, melamine oxalate, melamine phosphate, melamine pyrophosphate, polymeric melamine phosphate, and melamine cyanurate. Melamine cyanurate is a preferred non-fusible flame retardant used in the composition of the present invention.

In an embodiment of the composition of the present invention, the flame retardant may contain less than 90 wt. %, or less than 50 wt. %, or less than 35 wt. %, or less than 25 wt. %, or less than 10 wt. %, or less than 5 wt. % of the non-fusible flame retardant component, or may contain no non-fusible flame retardant component. In an embodiment of the composition of the present invention, the flame retardant PTT polymer composition may be comprised of at most 10 wt. %, or at most 5 wt. %, or at most 2.5 wt. % of a particulate non-fusible flame retardant component.

If present, the non-fusible flame retardant component of the flame retardant in the composition may be particulate. The particle size of the non-fusible flame retardant component of the composition of the invention may range up to a mean particle size of 150 μm. In an embodiment, the mean particle size of the non-fusible flame retardant component of the flame retardant is at most 10 μm, or the non-fusible flame retardant may contain nanoparticles and may have a mean particle size of at most 1 μM. Smaller mean particle size of the non-fusible flame retardant in the composition provides at least two benefits in the composition 1) more homogeneous dispersion of the particulate flame retardant in the composition; and 2) reduced breakage induced in fibers melt spun from the composition as a result of large particulates in the melted composition. In an embodiment, the non-fusible flame retardant component of the flame retardant is melamine cyanurate having a mean particle size of at most 10 μm, or at most 1 μm.

The flame retardant including the flame retardant meltable phosphinate metal salt and, if present, a non-fusible flame retardant component, may be present in the flame retardant PTT polymer composition in an amount of up 25 wt. % of the composition, or up to 15 wt. % of the composition, or up to 10 wt. % of the composition, or up to 5 wt. % of the composition—where the flame retardant meltable phosphinate metal salt of the flame retardant may be present in the composition only up to 5 wt. % of the composition. The flame retardant may be present in the flame retardant PTT polymer composition in an amount of from 0.25 wt. % to 25 wt. %, or from 0.3 wt. % to 20 wt. %, or from 0.5 wt. % to 10 wt. % or from 1 wt. % to 5 wt. %.

In an embodiment of the invention, the flame retardant PTT polymer composition may be a resin. The resin may be useful for forming various materials from the flame retardant PTT polymer resin composition such as polymer moldings, films, fibers, and filaments.

In another embodiment of the composition of the invention, the flame retardant PTT polymer composition may be a polymer molding composition. The polymer molding composition may include a filler, a reinforcing material, and/or a modifying agent. In an embodiment of the invention, a polymer molding composition of the flame retardant PTT polymer may contain from 0 wt. % to 50 wt. % of a filler, and/or from 0 wt. % to 25 wt. % of a reinforcing agent, where the combined filler and reinforcing agent may be present in an amount of from 0 wt. % to 50 wt. % of the composition. The flame retardant PTT polymer molding composition may also contain from 0 wt. % to 40 wt. % of a modifying agent.

In another embodiment of the invention, the flame retardant PTT polymer composition may be film. A polymer film of the flame retardant PTT polymer may contain from 0 wt. % to 50 wt. % of a filler, and/or from 0 wt. % to 25 wt. % of a reinforcing agent, where the combined filler and reinforcing agent may be present in an amount of from 0 wt. % to 50 wt. % of the composition. The flame retardant PTT polymer film may also contain from 0 wt. % to 40 wt. % of a modifying agent.

In another embodiment of the invention the flame retardant PTT polymer composition may be a fiber or a filament. The flame retardant PTT polymer fiber or filament may contain at most 5 wt. % filler, and at most 5 wt. % of a modifying agent. Fillers and/or modifying agents may negatively affect the melt spinning of the PTT polymer composition by inducing breakage in the melt spun composition, therefore, it may be desirable to limit these materials in the flame retardant PTT polymer fiber or filament composition. In an embodiment of the invention, the flame retardant PTT polymer fiber or filament composition contains at most 2.5 wt. % filler, preferably at most 1 wt. % filler. A preferred filler in the flame retardant PTT polymer fiber or filament composition of the invention is a delustering agent, preferably titanium dioxide.

“Filler” as the term is used herein is defined as “a particulate or fibrous material having no flame retardant activity”. Filler is commonly used to provide stiffness to polymer compositions used in molding applications or as a delustering agent in polymer compositions used in films, filaments, and fibers. Examples of filler materials that may be included in the composition of the invention include fibrous materials such as glass fiber, asbestos fiber, carbon fiber, silica fiber, fibrous woolastonite, silica-alumina fiber, zirconia fiber, potassium titanate fiber, metal fibers, and organic fibers with melting points above 300° C. Other filler materials that be included in this embodiment of the composition of the invention include particulate or amorphous materials such as carbon black, white carbon, silicon carbide, silica, powder of quartz, glass beads, glass powder, milled fiber, silicates such as calcium silicate, aluminum silicate, clay, and diatomites, metal oxides such as iron oxide, titanium oxide, zinc oxide, and alumina, metal carbonates such as calcium carbonate and magnesium carbonate, metal sulfates such as calcium sulfate and barium sulfate, and metal powders. For delustering purposes when the polymer composition is to be used to produce a film, filament, or fiber, titanium dioxide is a preferred filler.

“Reinforcing agent” as the term is used herein, is defined as a material useful to provide structural strength and integrity to a polymer composition. Reinforcing agents may include polyamides, polycarbonates, polyesters, polyurethane elastomers, polystyrene, polyethylene, and polypropylene.

“Modifying agent”, as the term is used herein, is defined as a material useful to modify the physical, chemical, color, or electrical characteristics of the polymer composition, excluding filler materials and reinforcing agents, as defined above. Modifying agents may include conventional antioxidants, lubricants, dyes and other colorants, UV absorbers, and antistatic agents.

In one aspect, the present invention is a process for preparing a flame retardant PTT polymer composition of the invention described above. In the process of the present invention, a mixture is prepared at a temperature of from 180° C. to 280° C. of 1) a flame retardant comprising aflame retardant phosphinate metal salt and 2) a polymer comprising at least 75 wt. % poly(trimethylene terephthalate) comprised of at least 75 mol % PTT (the “PTT polymer”). The flame retardant phosphinate metal salt of the flame retardant is selected so that the phosphinate metal salt has a melting point equal to or below 280° C., or below 270° C., or below 250° C., or below 230° C., or below 200° C., or below 180° C. The temperature at which the mixture is prepared is selected so the flame retardant meltable phosphinate metal salt and the PTT polymer each have a melting point below the selected temperature so that the flame retardant meltable phosphinate metal salt may be dispersed homogeneously in the PTT polymer. The amount of flame retardant in the mixture is selected so the flame retardant meltable phosphinate metal salt is from 0.25 wt. % to 5 wt. %, or from 0.3 wt. % to 4 wt. %, or from 0.5 wt. % to 2.5 wt. % of the combined flame retardant and PTT polymer. The amount of the flame retardant in the mixture relative to the amount of polymer in the mixture is also selected so the mixture has an intrinsic viscosity of at least 0.7 dl/g, or at least 0.8 dl/g, or at least 0.9 dl/g.

The flame retardant to be used in the process of the present invention contains at least one flame retardant phosphinate metal salt having a melting point of equal to or below 280° C., or below 270° C., or below 250° C., or below 230° C., or below 200° C., or below 180° C. (the “meltable phosphinate metal salt” as defined above). The flame retardant meltable phosphinate metal salt comprises at least 10 wt. % of the flame retardant, or may comprise greater than 50 wt. % of the flame retardant, or may comprise at least 75 wt. % of the flame retardant. The flame retardant used in the process of the invention may consist essentially of the flame retardant meltable phosphinate metal salt.

The flame retardant meltable phosphinate metal salt may be any phosphinate metal salt having the structure shown in formula (I) and having a melting point equal to or below 280° C., or below 270° C., or below 250° C., or below 230° C., or below 200° C., or below 180° C.

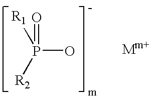

### (I)

In formula (I), R₁ and R₂ may be identical or different, and are C₁-C₁₈ alkyl, linear or branched, and/or aryl, M is Mg, Ca, Al, Sb, Ge, Ti, Fe, Zr, Ce, Bi, Sr, Mn, Li, Na, or K, and m is from 1 to 4. The flame retardant meltable phosphinate metal salt must have a melting point equal to or below 280° C., or below 270° C., or below 250° C., or below 230° C., or below 200° C., or below 180° C. so that it may be melted and dispersed in the PTT polymer at a temperature that will not substantially degrade the polymer.

In a preferred embodiment, the flame retardant meltable phosphinate metal salt is a zinc phosphinate having a melting point equal to or below 280° C., or below 270° C., or below 250° C., or below 230° C., or below 200° C., or below 180° C. and having the structure of formula (I) where R₁ and R₂ are identical or different and are hydrogen, C₁-C₁₈ alkyl, linear or branched, and/or aryl, M is zinc, and m is 2. In one embodiment the zinc phosphinate has a melting point of equal to or below 280° C., or below 270° C., or below 250° C., or below 230° C., or below 200° C., or below 180° C. and is of the formula (I), where R₁ and R₂ are identical or different and are methyl, ethyl, isopropyl, n-propyl, t-butyl, n-butyl, or phenyl, M is zinc, and m is 2. In a preferred embodiment, the zinc phosphinate is selected from the group consisting of zinc diethylphosphinate, zinc dimethylphospinate, zinc methylethylphosphinate, zinc diphenylphosphinate, zinc ethylbutylphosphinate, and zinc dibutylphosphinate. In most preferred embodiment, the zinc phosphinate is zinc diethylphosphinate.

The flame retardant utilized in the process of the invention may contain a flame retardant that does not have a melting point equal to or below 280° C., which, in accordance with the definition above, is defined as a “non-fusible flame retardant component”. The non-fusible flame retardant component of the flame retardant, if present, does not have a melting point equal to or below 280° C., although the non-fusible flame retardant component may, but does not necessarily, have a melting point above 280° C. since the non-fusible flame retardant component may decompose rather than melt. Such non-fusible flame retardants may include phosphinate metal salts of the formula (I) that do not melt at or below a temperature of 280° C. such as calcium diethylphosphinate, other phosphorous containing compounds that are non-fusible at a temperature equal to or below 280° C., including inorganic phosphorous compounds such as red phosphorous, monomeric organic phosphorous compounds, orthophosphoric esters or condensates thereof, phosphoric ester amides, phosphonitrilic compounds, phosphine oxides (e.g. triphenylphosphine oxides), and metal salts of phosphoric, and phosphonic acids, diphosphinic salts, and nitrogen containing compounds such as benzoguanamine compounds, ammonium polyphosphate, and melamine compounds such as melamine borate, melamine oxalate, melamine phosphate, melamine pyrophosphate, polymeric melamine phosphate, and melamine cyanurate. Melamine cyanurate is a preferred non-fusible flame retardant used in the flame retardant in the process of the present invention.

The non-fusible flame retardant component of the flame retardant used in the process of the invention may be particulate. The particle size of the non-fusible flame retardant component may range up to a mean particle size of 150 μm. In an embodiment, the mean particle size of the non-fusible flame retardant component of the flame retardant is at most 10 μm, or the non-fusible flame retardant component of the flame retardant may contain nanoparticles and may have a mean particle size of at most 1 μm. In an embodiment, the non-fusible flame retardant component of the flame retardant used in the process of the invention is melamine cyanurate having a mean particle size of at most 10 μm, or at most 1 μm.

The mixture of the flame retardant and the PTT polymer is prepared in the process of the invention so that the flame retardant PTT polymer has an intrinsic viscosity of at least 0.7 dl/g. In order to ensure that the flame retardant PTT polymer has an intrinsic viscosity of at least 0.7 dl/g, the amount of flame retardant in the mixture relative to the amount of polymer is selected so the mixture has an intrinsic viscosity of at least 0.7 dl/g, or at least 0.8 dl/g, or at least 0.9 dl/g. Addition of the flame retardant comprising the meltable phosphinate metal salt may reduce the intrinsic viscosity of the polymer to which the flame retardant is added due to the meltable phosphinate metal salt component of the flame retardant. One skilled in the art may determine the appropriate amount of flame retardant to mix with the polymer without undue experimentation based on the amount of meltable phosphinate metal salt in the flame retardant and the intrinsic viscosity of the polymer with which the flame retardant is mixed or the reaction conditions under which the polymer is formed while being mixed with the flame retardant. In general, as the concentration of the meltable phosphinate metal salt in the mixture increases the intrinsic viscosity of the mixture decreases, and conversely, as the concentration of the meltable phosphinate metal salt in the mixture decreases the intrinsic viscosity of the mixture increases. The concentration of the meltable phosphinate metal salt in the mixture may be increased by increasing the proportion of the meltable phosphinate metal salt in the flame retardant and/or by increasing the amount of flame retardant in the mixture. Likewise, the concentration of the meltable phosphinate metal salt in the mixture may be decreased by decreasing the proportion of the meltable phosphinate metal salt in the flame retardant and/or by decreasing the amount of the flame retardant in the mixture. As such, larger quantities of flame retardant and/or flame retardant having a higher proportion of meltable phosphinate metal salt may be mixed with the PTT polymer when the PTT polymer has an intrinsic viscosity significantly above 0.7 dl/g (e.g. greater than 0.85 dl/g) or when reaction conditions are selected at which a PTT polymer having an intrinsic viscosity significantly above 0.7 dl/g is formed. Conversely, smaller quantities of flame retardant and/or flame retardant having a lower proportion of the meltable phosphinate metal salt may be mixed with the PTT polymer when the polymer has an intrinsic viscosity slightly above 0.7 dl/g (e.g. 0.85 dl/g or less) or when reaction conditions are selected at which a polymer having an intrinsic viscosity slightly above 0.7 dl/g is formed.

The relative amount of flame retardant to the PTT polymer may be selected based on proportion of flame retardant meltable phosphinate metal salt in the flame retardant and the intrinsic viscosity of the PTT polymer. The relative amount of flame retardant to the PTT polymer may be selected so that the amount of flame retardant meltable phosphinate metal salt in the mixture is at most 5 wt. % of the mixture and the mixture has an intrinsic viscosity of at least 0.7 dl/g, or at least 0.8 dl/g, or at least 0.9 dl/g. In an embodiment, the amount of flame retardant relative to the PTT polymer may be selected so that the amount of flame retardant meltable phosphinate metal salt in the mixture is not more than 4 wt. %, or not more than 3 wt. %, or not more than 2.5 wt. %, or not more than 2 wt. %, or not more than 1 wt. % and the mixture has an intrinsic viscosity of at least 0.7 dl/g, or at least 0.8 dl/g, or at least 0/9 dl/g.

In an embodiment of the process of the invention, the flame retardant meltable phosphinate metal salt may comprise greater than 50 wt. % of the flame retardant, and the amount of flame retardant is selected so that the weight ratio of the flame retardant to the PTT polymer in the mixture is in a range from 1:400 up to, but not including, 1:10, or from 1:100 to 1:20, or from 1:50 to 1:25, where the mixture has an intrinsic viscosity of at least 0.7 dl/g or at least 0.8 dl/g, or at least 0.9 dl/g at the selected weight ratio. In another embodiment of the process of the invention, the flame retardant meltable phosphinate metal salt may comprise from 10 wt. % to 50 wt. % of the flame retardant, and the amount of flame retardant is selected so the weight ratio of the flame retardant to the PTT polymer in the mixture is in a range of from 1:200 up to, but not including, 1:1, or from 1:100 to 1:5, or from 1:50 to 1:10, where the mixture has an intrinsic viscosity of at least 0.7 dl/g, or at least 0.8 dl/g, or at least 0/9 dl/g.

The flame retardant may be mixed with the PTT polymer at a temperature of from 180° C. to 280° C. either in the polymerization process of forming the PTT polymer or after the PTT polymer has been formed by polymerization. The temperature at which the flame retardant and the PTT polymer are mixed should be above the melting point of the PTT polymer and the flame retardant meltable phosphinate metal salt of the flame retardant.

In an embodiment of the process of the present invention, the flame retardant is mixed with 1,3-propanediol (“PDO”), terephthalic acid (“TPA”), PTT polymer, and, optionally, non-PTT co-monomers in the process of producing the PTT polymer. The PTT polymer can be made by the esterification of PDO with TPA followed by optional prepolycondensation of the reaction product and polycondensation, preferably with a mole excess of PDO and, also preferably, wherein the reaction conditions include maintenance of relatively low concentrations of PDO and TPA in the melt reaction mixture. Polymerization of PTT from PDO and TPA may be performed in a continuous process or a batch process.

In the esterification step, the instantaneous concentration of unreacted PDO in the reaction mass may be maintained relatively low to obtain high intrinsic viscosity PTT polymer. This is accomplished by regulation of pressure and monomer feed. PDO and TPA may be fed to a reaction vessel in a total feed molar ratio within the range of about 1.1:1 to about 3:1. The preferred PDO:TPA feed ratio is from about 1.1:1 to 1.5:1 to minimize the amount of acrolein byproduct produced. The PDO and TPA may be added gradually so as to allow time to allow the conversion to ester to take place and keep the PDO and TPA concentrations low.

Also, to maintain the desired instantaneous concentration of PDO in the esterification step, it is preferred that a relatively low reaction pressure be maintained, although the esterfication step may be conducted at pressures greater than atmospheric. The pressure in a low pressure esterification step may be maintained below 0.3 MPa absolute, generally within the range of about 0.07 to about 0.15 MPa absolute. The temperature of the esterification step may be from 240° C. to 270° C. The time of the esterification step may range from 1 hour to 4 hours.

An esterification catalyst is optional in an amount of from 5 parts per million (ppm) to 100 ppm (metal), or from 5 ppm to 50 ppm, based on the weight of the final polymer. The esterification catalyst may be of relatively high activity and resistant to deactivation by the water byproduct of the esterification step. Such esterification catalysts include titanium and zirconium compounds, including titanium alkoxides and derivatives thereof, such as tetra(2-ethylhexyl)titanate, tetrastearyl titanate, diisopropoxy bis(acetylacetonato)titanium, di-n-butoxy-bis(triethanolaminoato)titanium, tributylmonoacetyl titanate, and tetrabenzoic acid titanate; titanium complex salts such as alkyl titanium oxalates and malonates, potassium hexafluoro titantate and titanium and titanium complexes with hydroxy carboxylic acids such as tartaric acid, citric acid, or lactic acid, catalysts such as titanium dioxide/silicon dioxide coprecipitate, and hydrated alkaline-containing titanium dioxide; and the corresponding zirconium compounds. Catalysts of other metals, such as antimony, tin, zinc, and the like can also be used. A catalyst useful for both esterification and polycondensation steps in preparing the PTT polymer is titanium tetrabutoxide.

Non-PTT co-monomers may be included in the esterification step. Non-PTT co-monomers include, but are not limited to, ethylene glycol, 1,4-butanediol, 1,4 cyclohexanedimethanol, oxalic acid, succinic acid, phthalic acid, 2,6-naphthalenedicarboxylic acid, 5-sodiumsulfoisophthalic acid, isophthalic acid, and/or adipic acid.

A precondensation (prepolymerization) step is optional in this embodiment of the process, but is useful to obtain a high intrinsic viscosity PTT polymer. If such a step is carried out, the pressure on the esterification product mixture is reduced to less than 0.02 MPa and the temperature is maintained within the range of 250° C. to 270° C., and the precondensation may be effected in less than 2 hours. The precondensation step, particularly in a continuous process, may be carried out in two vacuum stages, where the pressure is decreased in the second stage. Non-PTT co-monomers may be added in the precondensation step for inclusion in the PTT polymer, and include the non-PTT co-monomers described above.

In the polycondensation (or polymerization) step of this embodiment of the process, the reaction mixture may be maintained under vacuum at a pressure of from 2 to 25 Pa, and a temperature of from 245° C. to 270° C. for a period of from 1 to 6 hours until a PTT polymer is obtained having an intrinsic viscosity of from 0.7 dl/g to 1.5 dl/g. The polycondensation step is suitably carried out in a high surface area generation reactor capable of large vapor mass transfer such as a cage-type basket, perforated disc, disc ring, or twin screw reactor. The polycondensation may be carried out in the presence of a metal polycondensation catalyst, such as the titanium compounds described above. Titanium butoxide is an effective polycondensation catalyst for producing PTT polymer, and may be used in amounts of from 25 ppm to 100 ppm titanium. Non-PTT co-monomers may be added in the polycondensation step for inclusion in the PTT polymer, and include the non-PTT co-monomers described above.

Non-PTT co-monomers added for inclusion in the PTT polymer at the esterification, pre-polycondensation, and/or polycondensation steps may be added in an amount to provide a molar ratio of non-PTT co-monomer to the PTT co-monomer diol or acid which the non-PTT co-monomer is intended to replace in the polymer chain of at most 1:4 so that the PTT polymer contains at least 75 mol % trimethylene terephalate units in the polymer chain. In an embodiment, the non-PTT co-monomers may be added in an amount effective to provide a molar ratio of non-PTT co-monomer to the PTT co-monomer diol or acid which the non-PTT co-monomer is intended to replace in the polymer chain of at most 1:10. In another embodiment, no non-PTT co-monomers are added in the production of the PTT polymer so that the PTT polymer is a PTT homopolymer.

To form the flame retardant/PTT polymer mixture, the flame retardant containing the flame retardant meltable phosphinate metal salt may be added in the process for producing PTT polymer from PDO and TPA at the beginning of the process—such as being mixed with one or both of the feed reactants or added independently—during the process—such as in the esterification stage or in the optional prepolycondensation stage or in the polycondensation stage—or after polycondensation while PTT is still in molten form. The flame retardant may be mixed with the PTT to create the flame retardant/PTT polymer mixture as the PTT polymer is formed, for example in the esterification stage, or after the polymer is formed, for example after polycondensation while PTT is still in molten form.

The flame retardant is mixed with the PTT polymer at a temperature above the melting point of the PTT polymer and the flame retardant meltable phosphinate metal salt of the flame retardant, where the temperature is within the range of from 180° C. to 280° C., preferably a temperature of from 245° C. to 270° C. Preferably the flame retardant and the PTT polymer are well mixed when contacted at a temperature above the melting point of the PTT polymer and the meltable phosphinate metal salt of the flame retardant so as to provide a homogeneous dispersion of the flame retardant in the PTT polymer.

In another embodiment, the flame retardant is mixed with 1,3-propanediol (“PDO”), dimethylterephthalate (“DMT”), and PTT polymer in the process of producing the PTT polymer. PTT polymer can be made by the transesterification of PDO with DMT followed by optional prepolycondensation of the reaction product and polycondensation, preferably with a mole excess of PDO and, also preferably, wherein the reaction conditions include maintenance of relatively low concentrations of PDO and DMT in the melt reaction mixture. Polymerization of PTT from PDO and DMT may be performed in a continuous process or a batch process.

The process steps for producing PTT polymer from PDO and DMT are similar to those described above for producing PTT polymer from PDO and TPA except that DMT is substituted for TPA in the process. Non-PTT co-monomers may be added in the process as described above with respect to producing PTT polymer from PDO and TPA. The flame retardant containing the flame retardant meltable phosphinate metal salt may be added to the process for producing PTT polymer from PDO and DMT at the beginning of the process—such as being mixed with one or both of the feed reactants or added independently—during the process—such as in the transesterification stage or in the optional prepolycondensation stage or in the polycondensation stage—or after polycondensation while PTT is still in molten form as described above with respect to mixing the flame retardant with PTT polymer formed by polymerizing PDO and TPA. The flame retardant is mixed with the PTT polymer at a temperature above the melting point of the PTT polymer and the flame retardant meltable phosphinate metal salt of the flame retardant, also as described above.

In another embodiment, the flame retardant comprising the flame retardant meltable phosphinate metal salt may be mixed with PTT polymer after the polymerization process, for example, with a pelletized solid PTT polymer which is heated to a temperature above the melting point of the PTT polymer and the flame retardant meltable phosphinate metal salt. The flame retardant may be contacted with the PTT polymer prior to heating and be mixed with the PTT polymer after being heated above the melting point of the PTT polymer and the flame retardant meltable phosphinate metal salt, or the flame retardant may be contacted with the molten PTT polymer after it is heated to above the melting point of the PTT polymer, and mixed with the PTT polymer after the PTT polymer and flame retardant are heated above the melting point of both the PTT polymer and flame retardant meltable phosphinate metal salt. In either case, the flame retardant is mixed with the PTT polymer at a temperature above the melting point of the PTT polymer and above the melting point of the phosphinate metal salt of the flame retardant.

In an embodiment of the process of the present invention, the flame retardant comprising the flame retardant meltable phosphinate metal salt and the PTT polymer comprising at least 75 wt. % poly(trimethylene terephthalate) comprised of at least 75 mol % trimethylene terephthalate are contacted, heated, and mixed together in an extruder at a temperature above the melting point of the PTT polymer and above the melting point of the flame retardant meltable phosphinate metal salt of the flame retardant to produce the flame retardant PTT containing polyester.

In an embodiment of the process of the invention, a supplementary polymer may be mixed with the PTT polymer and the flame retardant at a temperature of from 180° C. to 280° C. The supplementary polymer should have a melting point below 280° C. so the supplementary polymer can be melted and mixed with the flame retardant and the PTT polymer, and the mixing temperature should be selected so that the supplementary polymer, the flame retardant meltable phosphinate metal salt of the flame retardant, and the PTT polymer have a melting point below the selected temperature. The supplementary polymer may be selected from the group consisting of polyesters and polyamides. In an embodiment, the supplementary polymer may be poly(ethylene terephthalate), poly(butylene terephthalate), poly(ethylene naphthalate), poly(trimethylene naphthalate), poly(ε-caproamide), poly(hexamethylene adipamide), or mixtures thereof. In an embodiment, the supplementary polymer is selected to be poly(ε-caproamide), poly(hexamethylene adipamide), or a mixture thereof so that the mixture of supplementary polymer, PTT polymer, and flame retardant has an increased viscosity, and fibers melt spun from the mixture have an increased tenacity, relative to the PTT polymer and flame retardant without the supplementary polymer. The amount of supplementary polymer may be selected so the supplementary polymer is present in an amount of up to 25 wt. %, or up to 15 wt. %, or up to 10 wt. %, or up to 5 wt. % of the mixture of flame retardant, PTT polymer, and supplementary polymer. In another embodiment, the flame retardant further comprises a polymer having a melting point equal to or below 280° C. blended with the flame retardant meltable phosphinate metal salt. The flame retardant comprising the polymer and flame retardant meltable metal salt and the PTT polymer may be mixed at a temperature of from 180° C. to 280° C. where the temperature is selected so that the PTT polymer, the flame retardant meltable salt, and the polymer of the flame retardant each have a melting point below the selected mixing temperature. The amount of flame retardant containing the polymer may be selected so that 1) the flame retardant meltable phosphinate metal salt is from 0.25 wt. % to 5 wt. %, or from 0.3 wt. % to 4 wt. %, or from 0.5 wt. % to 2.5 wt. % of the combined flame retardant and PTT polymer, 2) the mixture has an intrinsic viscosity of at least 0.7 dl/g, and 3) the mixture contains at least 75 wt. % poly(trimethylene terephthalate) containing at least 75 mol % trimethylene terephthalate.

The flame retardant comprising the meltable phosphinate metal salt and a polymer having a melting point of equal to or less than 280° C. may be formed by contacting, heating, and mixing a flame retardant meltable phosphinate metal salt having a melting point of equal to or below 280° C. and a polymer having a melting point of equal to or below 280° C. at a mixing temperature selected so that the mixing temperature is above the melting points of the flame retardant meltable phosphinate metal salt and the polymer. The amount of flame retardant meltable phosphinate metal salt mixed with the polymer may be selected so the mixture of flame retardant meltable phosphinate metal salt and the polymer contains from 0.5 wt. % to 70 wt. %, or from 2 wt. % to 50 wt. %, or from 3 wt. % to 40 wt. %, or from 4 wt. % to 30 wt. %, or from 5 wt. % to 25 wt. % of the flame retardant meltable phosphinate metal salt. The flame retardant meltable phosphinate salt in the flame retardant comprising a polymer may be selected from one or more of the flame retardant meltable phosphinate metal salts described above. In an embodiment, the polymer of the flame retardant may be selected to be a polyamide or a polyester, and may be selected from the group consisting of poly(trimethylene terephthalate), poly(ethylene terephthalate), poly(butylene terephthalate), poly(ethylene naphthalate), poly(trimethylene naphthalate), poly(ε-caproamide), poly(hexamethylene adipamide), or mixtures thereof. In an embodiment, the flame retardant comprising a polymer may have an intrinsic viscosity of at least 0.7 dl/g. In an embodiment, the flame retardant comprising a polymer has an intrinsic viscosity of less the 0.7 dl/g.

In an embodiment of the process of the invention, after the flame retardant and the PTT polymer are mixed, however they are mixed, the mixture containing the flame retardant and the PTT polymer may be cooled to form a flame retardant PTT polymer resin. The mixture may be cooled to form the resin by cooling the mixture to a temperature of less than 150° C., and preferably to a temperature of from 10° C. to 40° C.

In an embodiment of the process of the invention, the flame retardant PTT polymer is formed into a molding composition. The flame retardant PTT polymer may be formed into a molding composition in accordance with conventional processes for forming polymer molding compositions including injection molding, foam injection molding, blow molding, internal gas pressure molding and compression molding. Prior to or during the molding process from 0 wt. % to 50 wt. % of a filler, as defined above, may be added to the flame retardant PTT polymer, and/or from 0 wt. % to 25 wt. % of a reinforcing agent, as defined above, may be added to the flame retardant PTT polymer, and/or from 0 wt. % to 40 wt. % of a modifying agent, as defined above, may be added to the flame retardant PTT polymer—where the filler, reinforcing agent, and/or modifying agent are preferably added to the flame retardant PTT polymer when the polymer is in a molten state. If both a filler and a reinforcing agent are added to the flame retardant PTT polymer in the process of forming a molding composition, it is preferred that the combined filler and reinforcing agent do not exceed 50 wt. % of the molding composition.

In an embodiment of the process of the invention, the flame retardant PTT polymer is formed into a film. The flame retardant PTT polymer may be formed into a film in accordance with conventional processes for forming polymer films including film casting, lamination, or coating. Prior to or during the film-making process from 0 wt. % to 50 wt. % of a filler, as defined above, may be added to the flame retardant PTT polymer, and/or from 0 wt. % to 25 wt. % of a reinforcing agent, as defined above, may be added to the flame retardant PTT polymer, and/or from 0 wt. % to 40 wt. % of a modifying agent, as defined above, may be add to the flame retardant PTT polymer—where the filler, reinforcing agent, and/or modifying agent are preferably added to the flame retardant PTT polymer when the polymer is in a molten state. If both a filler and a reinforcing agent are added to the flame retardant PTT polymer in the process of forming a film, it is preferred that the combined filler and reinforcing agent do not exceed 50 wt. % of the film.

In an embodiment of the process of the invention, the flame retardant PTT polymer is formed into melt blown fiber or filament. The flame retardant PTT polymer may be formed into melt blown fiber or filament in accordance with conventional processes for forming melt blown polymer fibers and filaments. Prior to or during the fiber or filament-making process from 0 wt. % to 50 wt. % of a filler, as defined above, may be added to the flame retardant PTT polymer, and/or from 0 wt. % to 25 wt. % of a reinforcing agent, as defined above, may be added to the flame retardant PTT polymer, and/or from 0 wt. % to 40 wt. % of a modifying agent, as defined above, may be add to the flame retardant PTT polymer—where the filler, reinforcing agent, and/or modifying agent are preferably added to the flame retardant PTT polymer when the polymer is in a molten state. If both a filler and a reinforcing agent are added to the flame retardant PTT polymer in the process of forming a filament, it is preferred that the combined filler and reinforcing agent do not exceed 50 wt. % of the filament. In one embodiment of the invention, filler such as titanium dioxide is particularly useful as a delustering agent in the formation of flame retardant PTT polymer fibers or filaments.

In another embodiment of the process of the invention, the flame retardant PTT polymer may be spun into a fiber or filament. The flame retardant PTT polymer may be formed into a fiber or filament in accordance with conventional process for spinning fibers or filaments from polymers, for example by melt spinning processes. In a preferred embodiment for spinning a fiber or filament, at most 5 wt. %, or at most 2.5 wt. %, or at most 1 wt. % of a filler, as defined above, may be mixed with the flame retardant PTT polymer prior to spinning the fiber or filament. In one embodiment of the invention, filler such as titanium dioxide is particularly useful as a delustering agent in the formation of flame retardant PTT polymer spun fibers or filaments In another embodiment, it may be preferred to minimize particulates such as fillers mixed with the flame retardant PTT polymer prior to spinning the polymer into a fiber or filament to limit or eliminate breakage of the fiber or filament during the melt spinning process. In another embodiment, from 0 wt. % to 5 wt. % of a reinforcing agent, as defined above, and/or from 0 wt. % to 5 wt. % of a modifying agent, as defined above, may be added to the flame retardant PTT polymer prior to spinning the polymer into a fiber or filament.

What is claimed is:

1. A flame retardant polymer composition, comprising:
a polymer comprising at least 75 wt. % poly(trimethylene terephthalate) comprised of at least 75 mol % trimethylene terephthalate; and
a flame retardant comprising a flame retardant phosphinate metal salt having a melting point of equal to or below 280° C., wherein said phosphinate metal salt comprises from 0.25 wt. % to 5 wt. % of the composition, and wherein the composition has an intrinsic viscosity of at least 0.7 dl/g.

2. The flame retardant polymer composition of claim 1, wherein said phosphinate metal salt comprises from 0.5 wt. % to 2.5 wt. % of the composition.

3. The flame retardant polymer composition of claim 1 wherein the flame retardant phosphinate metal salt comprises greater than 50 wt. % of the flame retardant.

4. The flame retardant polymer composition of claim 1 wherein the flame retardant phosphinate metal salt is a zinc phosphinate having the formula (I) 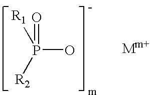
(I)
or a polymer thereof, where:
R₁ and R₂ are identical or different and are selected from the group consisting of hydrogen, C₁-C₁₈ alkyl, and C₁-C₁₈ aryl;
M is zinc; and
m is 2.

5. The flame retardant polymer composition of claim 4 wherein the zinc phosphinate is selected from the group consisting of zinc diethylphosphinate, zinc dimethylphosphinate, zinc methylethylphosphinate, zinc diphenylphosphinate, zinc ethylbutylphosphinate, zinc dibutylphosphinate, and mixtures thereof.

6. The flame retardant polymer composition of claim 5 wherein the zinc phosphinate is zinc diethylphosphinate.

7. The flame retardant polymer composition of claim 1 wherein the flame retardant further comprises a particulate non-fusible flame retardant component.

8. The flame retardant polymer composition of claim 7 wherein the particulate non-fusible flame retardant component comprises at most 10 wt. % of the composition.

9. The flame retardant polymer composition of claim 1 further comprising a polymer selected from the group consisting of polyamides and polyesters other than polyesters comprising at least 75 wt. % poly(trimethylene terephthalate) comprised of at least 75 mol % triemethylene terephthalate, and mixtures thereof.

10. The flame retardant polymer composition of claim 1 wherein the composition is a polymer resin.

11. The flame retardant polymer composition of claim 1 wherein the composition is a polymer molding.

12. The flame retardant polymer composition of claim 1 wherein the composition is a polymer film.

13. The flame retardant polymer composition of claim 1 wherein the composition is a filament or a fiber.

14. A process for preparing a polymer containing a flame retardant, comprising:
preparing a mixture at a temperature of from 180° C. to 280° C. of
1) a flame retardant comprising a flame retardant phosphinate metal salt; and
2) a polymer comprising at least 75 wt. % poly(trimethylene terephthalate) comprised of at least 75 mol % trimethylene terephthalate, wherein:
a) the flame retardant phosphinate metal salt of the flame retardant is selected so that the flame retardant phosphinate metal salt has a melting point equal to or below 280° C.;
b) the temperature is selected so the polymer and the flame retardant phosphinate metal salt each have a melting point below the selected temperature;
c) the amount of flame retardant in the mixture is selected so the flame retardant phosphinate metal salt is from 0.25 wt. % to 5 wt. % of the combined flame retardant and polymer; and
d) the amount of flame retardant in the mixture relative to the amount of polymer in the mixture is selected so the mixture has an intrinsic viscosity of at least 0.7 dl/g.

15. The process of claim 14 wherein the mixture of the flame retardant and the polymer is prepared by mixing the flame retardant with
(a) 1,3-propanediol, terephthalic acid, and poly(trimethylene terephthalate) in a process of producing poly(trimethylene terephthalate); or
(b) 1,3-propanediol, dimethylterephthalate, and poly(trimethylene terephthalate) in a process of producing poly(trimethylene terephthalate); or
(c) a polymer comprising at least 75 wt. % poly(trimethylene terephthalate) comprised of at least 75 mol % trimethylene terephthalate.

16. The process of claim 14 wherein the flame retardant comprises from 0.25 wt. % to 5 wt. % of the combined flame retardant and polymer.

17. The process of claim 14 wherein the flame retardant phosphinate metal salt comprises greater than 50 wt. % of the flame retardant.

18. The process of claim 14 wherein the flame retardant phosphinate metal salt is a zinc phosphinate having the formula (I) 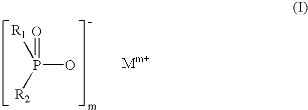
or a polymer thereof,
where R₁ and R₂ are identical or different and are selected from the group consisting of hydrogen, C₁-C₁₈ alkyl, and C₁-C₁₈ aryl;
M is zinc; and
m is 2.

19. The process of claim 18 wherein the zinc phosphinate is selected from the group consisting of zinc diethylphosphinate, zinc dimethylphosphinate, zinc methylethylphosphinate, zinc diphenylphosphinate, zinc ethylbutylphosphinate, zinc dibutylphosphinate, and mixtures thereof.

20. The process of claim 19 wherein the zinc phosphinate is zinc diethylphosphinate.

21. The process of claim 14 wherein the flame retardant further comprises a particulate non-fusible flame retardant component.

22. The process of claim 14 further comprising mixing the flame retardant and the polymer with a supplementary polymer selected from the group consisting of polyamides, polyesters other than polyesters comprised of at least 75 wt. % poly(trimethylene terephthalate) comprised of at least 75 mol % trimethylene terephthalate, and mixtures thereof wherein the mixing temperature is selected so the supplementary polymer has a melting point below the mixing temperature, and wherein the amount of supplementary polymer is selected so that the mixture contains at least 75 wt. % poly(trimethylene terephthalate).

23. The process of claim 14 wherein the flame retardant further comprises a polymer blended with said phosphinate metal salt, and said temperature is further selected so the polymer of the flame retardant has a melting point below the selected temperature.

24. The process of claim 23 wherein the polymer of the flame retardant is selected from the group consisting of poly(trimethylene terephthalate), poly(ethylene terephthalate), poly(butylene terephthalate), poly(ethylene naphthalate), poly(trimethylene naphthalate), poly(ε-caproamide), poly(hexamethylene adipamide), and mixtures thereof.
